(19) United States
(12) Patent Application Publication
(10) Pub. No.: US 2013/0024259 A1
(43) Pub. Date: Jan. 24, 2013

(54) SYSTEM AND METHOD FOR COUPON-LESS PRODUCT LEVEL DISCOUNTS

(71) Applicants: David M. Wolf, Brooklyn, NY (US); Lindsey C. Rhoads, New York City, NY (US); Manjushri H. Puranik, Scottsdale, AZ (US); Sherree Newhouse, Phoenix, AZ (US); Matthew James Miller, Phoenix, AZ (US); David William Boggess, Phoenix, AZ (US); Sathish B. Muthukrishnan, Phoenix, AZ (US); Charles Lafayette Kimes, Scottsdale, AZ (US)

(72) Inventors: David M. Wolf, Brooklyn, NY (US); Lindsey C. Rhoads, New York City, NY (US); Manjushri H. Puranik, Scottsdale, AZ (US); Sherree Newhouse, Phoenix, AZ (US); Matthew James Miller, Phoenix, AZ (US); David William Boggess, Phoenix, AZ (US); Sathish B. Muthukrishnan, Phoenix, AZ (US); Charles Lafayette Kimes, Scottsdale, AZ (US)

(73) Assignee: American Express Travel Related Services Company, Inc., New York, NY (US)

(21) Appl. No.: 13/468,880

(22) Filed: May 10, 2012

Related U.S. Application Data
(63) Continuation of application No. 13/188,693, filed on Jul. 22, 2011.

(51) Int. Cl. G06Q 30/02

(52) U.S. Cl. 705/14.23

(57) ABSTRACT

A product level discount is managed during a transaction by receiving a transaction identifier associated with a transaction, where the transaction identifier comprises a transaction value, a customer account identifier, a merchant identifier, and a product identifier. A product identifier is assessed to determine whether the transaction qualifies for a rebate credit in accordance with a predetermined offer. A rebate credit value is based on the transaction information and the predetermined offer, and qualification may be determined based on at least one of the customer account identifier and the merchant identifier. The product identifier could be a SKU code, which may be the basis for qualifying for the rebate credit. A merchant associated with the merchant identifier, which is part of the transaction, does not need to be informed of the application of the rebate credit to the customer account, which occurs after completion of the transaction.

### CROSS REFERENCE TO RELATED APPLICATION

This application is a continuation of U.S. Ser. No. 13/188,693, entitled “System and Method for Coupon-Less Product Level Discounts,” filed on Jul. 22, 2011. The entire disclosures of which are incorporated herein by reference.

### FIELD

The present disclosure generally relates to applying a product-level discount, and more particularly, to a method and system for a non-merchant providing discounts on a product level.

### BACKGROUND

Traditional merchant-implemented programs for discounting specific products have been around for years. Discount programs are typically used to help businesses reduce inventory by providing an incentive to customers. The discount is typically applied during the transaction, and may be a coupon or loyalty program discount. A typical example of a merchant-implemented discount is a grocer advertising a reduced price on a particular food product if the customer is a rewards card member. The discount is applied while checking out, and the customer pays a reduced price during the check out process.

In a standard merchant transaction using a transaction card for payment, a financial institution receives a transaction amount, merchant identifier, and a customer account identifier. Information regarding the specific purchased goods or services is not provided to the financial institution. Furthermore, a discount may be facilitated by a financial institution, but the discount offers are limited to storewide discounts at particular merchants. A particular merchant can establish a product discount, but that discount must be entered into a system by the merchant. Thus, it would be beneficial for a financial institution to have the ability to establish a discount at the product level, without the need for the discount to be implemented by the merchant.

### SUMMARY

Systems and methods for managing a product level discount are provided. In one embodiment, a product level discount may be managed, by a computer based system, during a transaction, The system may receive a transaction identifier associated with a transaction, where the transaction identifier comprises a transaction value, a customer account identifier, a merchant identifier, and a product identifier. The product identifier may be assessed, by the computer based system, to determine whether the transaction qualifies for a rebate credit in accordance with a predetermined offer. Furthermore, a value is determined of any rebate credit based on the transaction information and the predetermined oiler. In an exemplary embodiment, the computer based system for managing a product level discount comprises a network interface communicating with a memory, where the memory communicates with a processor for managing a product level discount, and the processor, when executing a computer program, is configured to receive, by the processor, the transaction identifier associated with a transaction, assess the product identifier to determine whether the transaction qualifies for the rebate credit in accordance with the predetermined offer, and determine the value of the rebate credit.

The product level discount management may include determining whether the transaction qualifies for the rebate credit, based on at least one of the customer account identifier and the merchant identifier. Furthermore, the product level discount management may also include verifying, by the computer based system, that the transaction has been completed, and applying the rebate credit to a customer account associated with the customer identifier after completion of the transaction. The product identifier could be a stock-keeping unit (SKU) code. The SKU code may be the basis for qualifying for the rebate credit. Furthermore, a merchant associated with the merchant identifier, which is part of the transaction, does not need to be informed of the application of the rebate credit to the customer account. From the viewpoint of a merchant, a product level discount may be applied post-transaction and the merchant may have no knowledge of the applied discount. In an embodiment, the product level discount management may include applying the rebate credit to the transaction at the point of sale, and determining authorization of the transaction after the applying the rebate credit.

The predefined offer may be sent to the user associated with the customer account identifier to incentivize completion of the transaction. The determination of who receives the predefined over can be based (at least in part) on the transaction history of the user. Furthermore, the qualification for the rebate credit may be based (at least in part) on an aggregate transaction history of the user associated with the customer account identifier. Also, the qualification for the rebate credit may be based (at least in part) on the product identifier corresponding to at least one of a particular product or a vendor. A user (or customer in this case) can receive the predefined offer in a variety of ways. For example, the customer can also receive the predefined offer on a portable electronic device. Moreover, in one embodiment, the customer account identifier may include a unique identifier associated with the portable electronic device. The unique identifier associated with the portable electronic device may be used to match the transaction to the customer account identifier.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 includes a flow chart illustrating a process of a financial institution for managing a product-level discount, in an exemplary embodiment;

FIG. 2 includes a flow chart illustrating a process of a user in a product-level discount system, in an exemplary embodiment; and

FIGS. 3A-3B includes flow charts illustrating an exemplary process for transmitting transaction information in a product-level discount management system, in accordance with an exemplary embodiment.

### DETAILED DESCRIPTION

The detailed description of exemplary embodiments herein shows exemplary embodiments by way of illustration and its best mode. While these exemplary embodiments are described in sufficient detail to enable those skilled in the art to practice the disclosure, it should be understood that other embodiments may be realized and that logical, chemical and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step.

For the sake of brevity, conventional data networking, application development and other functional aspects of the systems (and components of the individual operating components of the systems) may not be described in detail herein.

In general, the systems and methods include a unique combination of one or more features associated with the redemption and application of a product-level discount to transactions charged or otherwise applied against a transaction account. More specifically, a system and method is disclosed for identifying transactions from a group of transactions charged to a transaction account, where the identified transactions represent predefined types of purchases. The predefined types of purchases may be determined or grouped in any manner. For example, the predefined types of purchases may be categorized by the type of merchants where the purchase was made, the type of items being purchased, the cost of the items being purchased, the time of purchase, the place of purchase and/or any other suitable manner. For example, where the predefined type of purchases are associated with transactions for everyday purchases (e.g. groceries, fuel purchases, dry cleaning services purchases), the system identifies certain transactions associated with the everyday purchases, and allows the user to apply a discount for a monetary credit that can be applied to the identified transactions.

Typically, transaction account issuer's have provided rewards or other benefits to customers who use their transaction accounts. Often transaction account issuers enter into strategic relationships with merchants to provide incentives for using a particular transaction account with a particular merchant. For example, American Express and Delta Airlines have partnered to allow American Express Cardmembers to receive an additional benefit on top of the benefit the Cardmember receives by simply using the card with a different merchant, who is not part of a strategic relationship. The strategic partner may provide the transaction account issuer with a fee for the strategic relationship. The strategic partner and the transaction account issuer may also work to develop a joint marketing plan to induce a customer to use a particular transaction account with a particular strategic partner. In addition to traditional advertisements, the strategic partner and the transaction account issuer may also provide benefits that induce the customer to conduct particular transactions in a particular manner. For example, the strategic partner may offer a discount to the customer where the customer makes a purchase of a particular item through a particular channel (e.g. the strategic partner's webpage). Similarly, the transaction account issuer may pay the strategic partner a fee or provide a discount on transaction fees in order to induce customers to patronize the strategic partner and use a particular transaction account. The strategic partner and/or transaction account issuer may have also developed related accounts (e.g., loyalty accounts) which were associated with the customer and accrued benefits based on patronage at a particular strategic partner with a particular transaction account.

Suppliers of everyday items and/or non-discretionary items have generally not partnered with transaction account issuers to form strategic relationships. The suppliers may institute their own discount program for reducing inventory. For example, merchant or manufacturer coupons and mailers may be used. Typically, the suppliers do not involve the transaction account issuers for promoting or incentivizing customers on a product-level.

Moreover, the transaction account issuer would generally like to engage strategic partners with a national presence and strong brand recognition. However, retailers that provide everyday items may have a more limited market focus, in that they have a regional market presence rather than a national market presence. This presents a challenge to creating strategic relationships because it often requires the transaction account issuer to seek out many strategic partners so that the transaction account issuer can serve and offer benefits to all of its customers across the various geographic regions the transaction account issuer serves. As such, and in accordance with an exemplary embodiment, the product discount management system may target specific types of transactions or transactions for specific types of products (e.g. transactions for grocery purchases) which may not be associated with a specific retailer or group of retailers. The transaction account issuer can align, with a manufacturer in an arrangement that applies to numerous retailers, without having to form individual relationships with the numerous retailers. Thus, the system allows transaction account issuers to overcome signing and retaining multiple partners by targeting specific types of purchases.

“User” may include any individual, customer, cardmember, employee, contractor, group, participant, beneficiary, account holder, account owner, recipient, charitable organization, software, hardware, and/or other entity that has an interest in a transaction account and/or a loyalty account award.

A “transaction account” as used herein refers to an account associated with an open account or a closed account system (as described below). The transaction account may exist in a physical or non-physical embodiment. For example, a transaction account may be distributed in non-physical embodiments such as an account code, frequent-flyer account, telephone calling account or the like. Furthermore, a physical embodiment of a transaction account may be distributed as a financial instrument (or card). The term “transaction instrument” is used herein to be synonymous with the term “transaction account,” unless indicated otherwise.

A “transaction account code,” “account,” “account number” or “account code,” as used herein, may include any device, code, number, letter, symbol, digital certificate, smart chip, digital signal, analog signal, biometric or other identifier/indicia suitably configured to allow a consumer to access, interact with or communicate with a financial transaction system. The account code may optionally be located on or associated with any financial transaction instrument (e.g., rewards, charge, credit, debit, prepaid, telephone, embossed, smart, magnetic stripe, bar code, transponder or radio frequency card).

“Item” as used herein may include any good, service, information, experience, data, content, access, rental, lease, contribution, account, credit, debit, benefit, right, monetary value, non-monetary value and/or the like.

While certain embodiments may include a “purchase”, such embodiments also contemplate the “purchase” being any exchange of items (e.g., paying for a lease, etc).

A “monetary value” or “credit value” as used herein, may include any statement credit, statement payment, statement debit, statement value, monetary credit, monetary transfer, credit monetary value, credit, discount, coupon, or similar benefit, provided to a user, directly or through a transaction account.

A “financial institution” may include any entity that offers transaction account services to recipients. Although often referred to as a “financial institution,” the financial institution may represent any type of bank, brokerage, lender or other type of account issuing institution. It is further noted that other participants may be involved in some phases of the transaction, such as an intermediary settlement institution.

A product level discount facilitated by a financial institution, separate from a merchant, is capable of helping move specific inventory. The inventory may be targeted for the discount due to a variety of factors, including approaching a limited shelf-life or making room for a replacement product. Furthermore, the discount may be greater than average if a supplier is able to limit to a specific product and/or merchant. In an embodiment, a supplier and a financial institution may partner to offer a discount for a product at a first retailer but not offer that same discount at a second retailer.

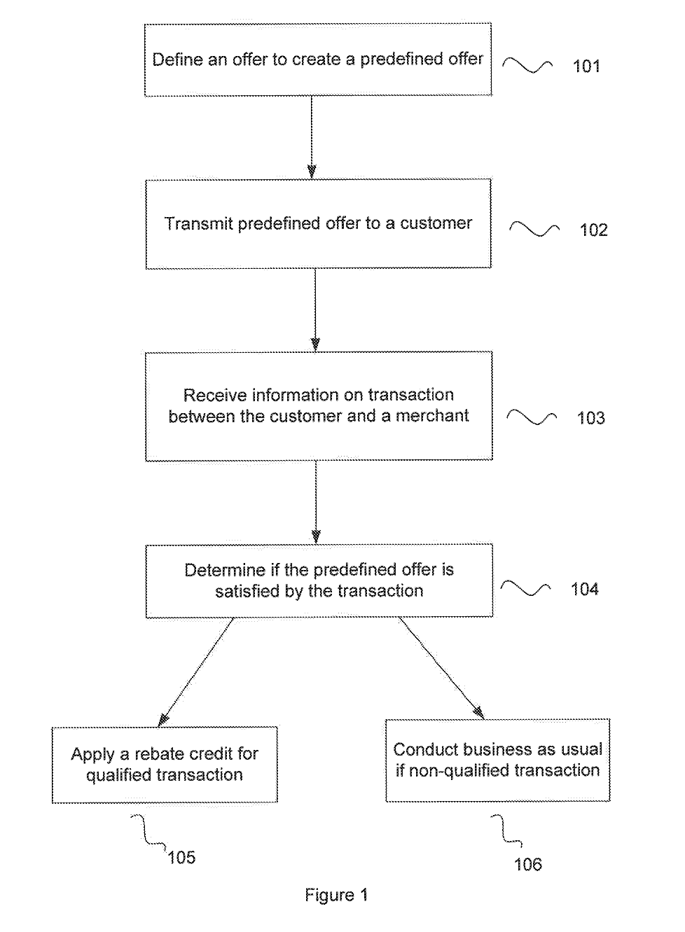

In one embodiment and with reference to FIG. 1, a product level discount may be managed (e.g., by a computer based system) during a transaction. The computer based system may be operated by a financial institution or a third party entity. The computer based system may define an offer to create a predefined offer 101. Furthermore, the predefined offer may be transmitted, by the computer based system, to a customer 102. In the embodiment, computer based system be configured to receive information about the transaction between the customer and a merchant. The computer based system may receive a transaction identifier associated with a transaction, where the transaction identifier comprises a transaction value, a customer account identifier, a merchant identifier, and/or a product identifier. The product identifier may be assessed 104, by the computer based system, to determine whether the transaction qualifies for a rebate credit in accordance with a predetermined offer. Furthermore, a value of a rebate credit is determined based on the transaction information and/or the predetermined offer. The rebate credit may be applied to a qualified transaction 105, or the transaction may proceed under business as usual standards in a non-qualified transaction 106.

In an exemplary embodiment, the computer based system for managing a product level discount comprises a network interface communicating with a memory, where the memory communicates with a processor for managing a product level discount, and the processor, when executing a computer program, is configured to receive, by the processor, the transaction identifier associated with a transaction, assess the product identifier to determine whether the transaction qualifies for the rebate credit in accordance with the predetermined offer, and determine the value of the rebate credit.

The predefined offer for the rebate credit can be established by various parties. For example, the predefined offer may be established by a transaction account issuer, a loyalty account issuer, a financial institution, a supplier, or a vendor. Furthermore, the predefined offer may be established by agreement of more than one party. The predefined offer may identify a transaction associated with an everyday purchase as an eligible transaction. The predefined offer may be associated with a specialty product or specific event.

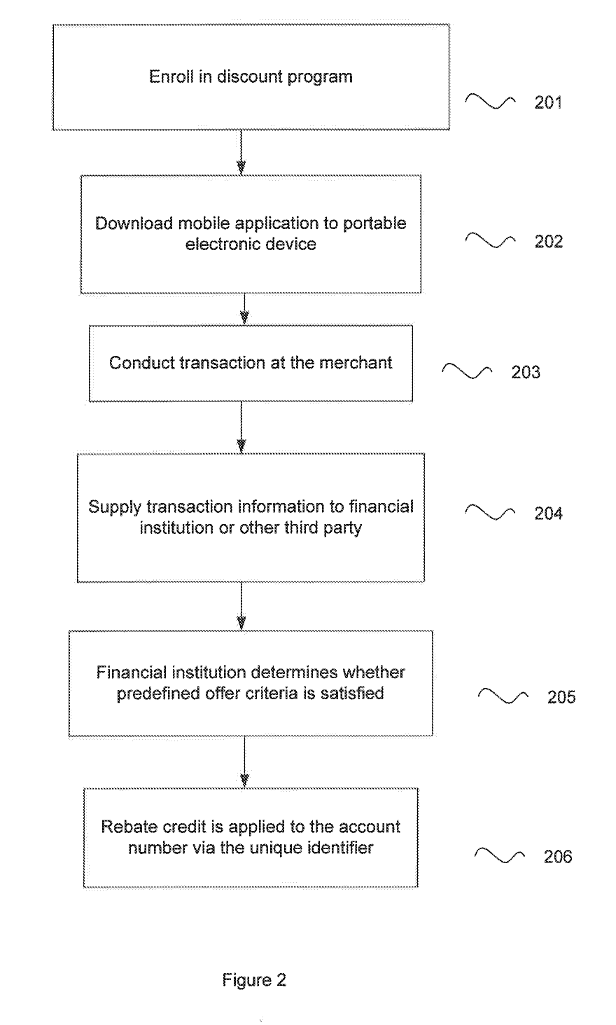

The predefined offer may be sent to the user associated with the customer account identifier to incentivize completion of the transaction. A user, or customer in this case, can receive the predefined offer in a variety of ways. For example, the customer can receive the predefined offer on a portable electronic device. In one embodiment and with reference to FIG. 2, a user may enroll in a discount program 201 and provide such information like an account code and a unique identifier. Furthermore, the user may download a mobile application to the portable electronic device 202. The user could be directly contacted with the predefined offer by one or more of email, a direct mailing, a communication to a phone, such as a text message, or by referral to a website. Moreover, in one embodiment, the customer account identifier may include a unique identifier associated with the portable electronic device. The unique identifier associated with the portable electronic device may be used to match the transaction to the customer account identifier. The unique identifier may be, for example, a phone number associated with the portable electronic device. A user conducts a transaction at a merchant 203, and then transaction information is transmitted to a financial institution or a third party 204. As previously described, the financial institution determines whether the predefined offer is satisfied by the transaction 205. If it is a qualified transaction, the rebate credit may be applied to the account code associated with the unique identifier 206.

The determination of which people to receive the predefined offer can be based at least in part on the transaction history of the user. Specifically, the qualification for the rebate credit may be based at least in part on an aggregate transaction history of the user associated with the customer account identifier. Also, the qualification for the rebate credit may be based at least in part on the product identifier corresponding to at least one of a particular product or a vendor.

In one embodiment, a product level discount may be facilitated by a point-of-sale (POS) terminal, during a transaction. The POS terminal may receive transaction information from at least one of a merchant and a customer, generate a transaction identifier, wherein the transaction identifier comprises a transaction value, a customer account identifier, a merchant identifier, and a product identifier. The POS terminal transmits the transaction identifier to a computer based system for managing a product level discount, where the computer based system determines whether a transaction qualifies for a rebate credit in accordance with a predefined offer based on at least the product identifier. In an exemplary embodiment, a point-of-sale terminal comprises a network interface communicating with a memory, the memory communicating with a processor for managing a product level discount, and the processor, when executing a computer program, is configured to receive, at the POS terminal, transaction information from at least one of a merchant and a customer, generate a transaction identifier, and transmit the transaction identifier to a computer based system for managing a product level discount, where the computer based system determines whether a transaction qualifies for a rebate credit in accordance with a discount offer based on the product identifier.

Furthermore, in one embodiment, the POS terminal provides the status of the transaction to the computer based system, where the computer based system applies the rebate credit to a customer account associated with the customer identifier after the completion of the transaction. The status of the transaction may be completed, pending, or cancelled. Moreover, in an embodiment, the merchant may not be informed of the application of the rebate credit to the customer account. In another embodiment, the rebate credit may be applied by the POS terminal to the transaction, and a request made by the POS terminal for authorization of the transaction after applying the rebate credit.

The transaction process involves two general aspects; authorization of the transaction and determination of a product discount qualification. The authorization of a transaction is a well known process and will not be discussed in detail. The product discount qualification. involves communicating the product identifier, such as a stock-keeping unit (SKU) code from a merchant to a computer based system, where the SKU-level data includes a routing indicator. The routing indicator may be used to separate the merchant communication into at least two data blocks, where the SKU-level data block is transmitted to a SKU database. A SKU code is a product identifier that uniquely identifies a particular product manufactured by a specific vendor. The product identifier may also include a transaction amount, a card member identifier, the SKU code, a SKU indicator, a merchant identifier, and/or country of transaction origin.

The product identifier may be communicated to the computer based system in multiple ways. In a first embodiment, the product identifier is received from a merchant where the transaction originated. The merchant may send the information via a batch file after a period of time, or on an individual transaction basis using the internet or other electronic communication connection. In a second embodiment, the product identifier is received from a customer by way of a transaction receipt. The customer may download a smartphone application capable of scanning the transaction receipt (e.g., a barcode on the receipt or a photo of the receipt) and transmit this information to the computer based system.

As previously mentioned, the product level discount management, in one embodiment, may include determining whether the transaction qualifies for the rebate credit based on at least one of the customer account identifier and the merchant identifier. Furthermore, the product level discount management may also include verifying, by the computer based system, that the transaction has been completed, and applying the rebate credit to a customer account associated with the customer identifier after completion of the transaction. The product identifier could be a stock-keeping unit (SKU) code. The SKU code may be the basis for qualifying for the rebate credit. Furthermore, a merchant associated with the merchant identifier, which is part of the transaction, does not need to be informed of the application of the rebate credit to the customer account. From the viewpoint of a merchant, a product level discount may be applied post-transaction and the merchant may have no knowledge of the applied discount. In another embodiment, the product level. discount management may include applying the rebate credit to the transaction at the point of sale, and determining authorization of the transaction after the applying the rebate credit. In this respect, if a customer has a transaction value limit, the transaction may be authorized after application of the rebate credit but not without the rebate credit.

The product level discount, in one embodiment, may include determining whether the transaction qualifies for the rebate credit based on at least one of the customer account identifier and the merchant identifier. Furthermore, the product level discount may also include crediting, at the POS terminal, the rebate credit to the transaction value and completing the transaction.

In an embodiment having the discount applied post-transaction, verification of several factors may occur before the appropriate discount level is applied. In one embodiment, implementation of the product-level discount involves little effort on the part of a merchant. The merchant provides the transaction information, such as via a point-of-sale terminal, where the transaction information includes the transaction identifier as previously defined. The merchant can opt-in to participate in third-party product level discounts and have minimal requirements to facilitate such a program. A software update to the PUS terminal will often be the only change needed at the merchant. The software update allows the PUS terminal to generate and communicate the transaction identifier. A financial institution, or any third-party establishing the predefined offer, receives the transaction identifier. As stated herein, the transaction identifier includes a customer account identifier. The customer account identifier may be used to retrieve customer information from a database, where the customer information may be part of the discount qualification determination. Such customer information may include geographic location, account history, prior purchase information (both product and merchant-based), account status, prior transaction values, loyalty account information, and the like.

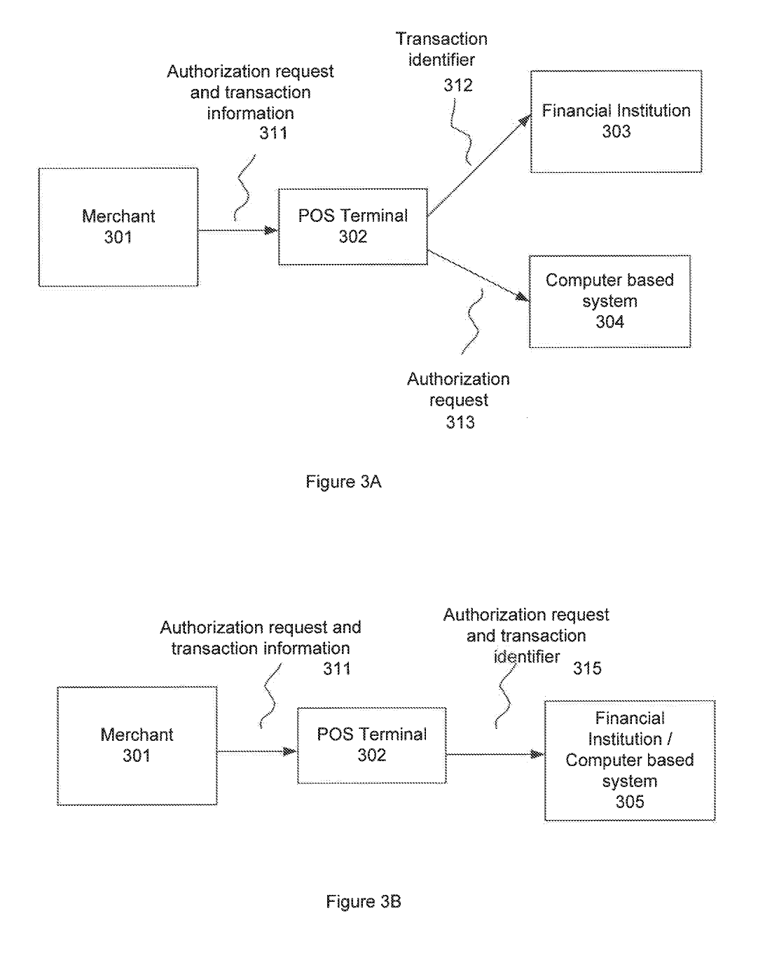

In addition, the POS terminal may also transmit the transaction identifier to a financial institution, where the financial institution is separate from the computer based system. As illustrated in FIG. 3A, a merchant 301 communicates an authorization request and transaction information 311 to a POS terminal 302. The POS terminal 302 forms a transaction identifier and transmits the transaction identifier 312 to a financial institution 303. The financial institution 303 receives transaction identifier 312 and separates a product identifier into a product database. A computer based system 304 receives the authorization request 313 from POS terminal 302. In another embodiment and with reference to FIG. 3B, is similar to the prior embodiment, except the computer based system 305 is the same as the financial institution, The financial institution 305 is configured, upon receipt of the transaction identifier 312, to separate a product identifier from the transaction identifier. The financial institution 305 then authorizes the transaction and determines whether the predefined offer is satisfied by the transaction. The financial institution matches the product information and/or the customer information with the merchant or manufacturer offers.

Furthermore, a SKU matching process comprises receiving SKU data from the merchant (POS terminal) and receiving the predefined offer, which is a compilation of the eligible record of charges. The SKU data and the predefined offer are then compared and matching records extracted to aid in the qualification determination. If a discount qualification is determined, the qualifying transaction notice is communicated to an internal discount process.

A product level discount management for use in a telecommunications network may also interface with the embodiments herein. In particular, such a system includes a mobile communication device configured to communicate over a wireless telecommunication network, a telecommunication service provider configured to facilitate a connection to the wireless telecommunication network, a rewards management system, a financial institution, and a communication network providing communication between the telecommunication service provider, the rewards management system, and the financial institution. The rewards management system includes a loyalty program configured to track activities which generate loyalty benefits, store the loyalty benefits, and determine a monetary value associated with the loyalty benefits and a loyalty program middleware which facilitates communication of the loyalty program with a financial institution such that the loyalty benefit can be used to satisfy obligations associated with a transaction account issued by the financial institution on the connection.

A product level discount management for a peer-to-peer transaction may also interface with the embodiments herein. In particular, such a system includes first and second. personal communication devices configured to participate in a peer-to-peer transaction, a rewards management system, and a communication network providing two-way communication between one of said personal communication devices and the rewards management system. The rewards management system includes a loyalty program configured to track activities which generate loyalty benefits, store the loyalty benefits, and determine a monetary value associated with the loyalty benefits and a loyalty program middleware which facilitates communication of the loyalty program with a financial institution such that the loyalty benefit can be used to satisfy obligations associated with a transaction account issued by the financial institution.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e.g. 123.4.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

An Internet server may invoke an authentication server in response to user submissions of authentication credentials received at the Internet server from a user interface. The authentication server may include any hardware and/or software suitably configured to receive authentication credentials, encrypt and decrypt credentials, authenticate credentials, and grant access rights according to privileges (e.g., pre-defined privileges) attached to the credentials. The authentication server may grant varying degrees of application and data level access to users based on information stored within a database and/or any other known memory structure.

One skilled in the art will appreciate that the discount management system may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGRIP, for example. In accordance with one aspect of system 100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 100 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

In addition to those described above, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include; client data; merchant data; financial institution data; and/or like data useful in the operation of the present disclosure. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” includes any cloud, cloud computing system or electronic communications system or method which incorporates hardware and/or software components, Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand, For more information regarding cloud computing, see the NIST's (National Institute of Standards and Technology) definition of cloud computing at http://csrc.nistgov/groups/SNS/cloud-computing/cloud-def-v15.doc (last visited Feb. 4, 2011), which is hereby incorporated by reference in its entirety.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The disclosure may be described herein in terms of functional block components, screen shots, optional selections and various processing steps. It should be appreciated that such functional blocks may be realized by any number of hardware and/or software components configured to perform the specified functions. For example, the discount management system may employ various integrated circuit components, e.g., memory elements, processing elements, logic elements, lookup tables, and/or the like, which may carry out a variety of functions under the control of one or more microprocessors or other control devices. Similarly, the software elements of the discount management system may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the discount management system may employ any number of conventional techniques for data transmission, signaling, data processing, network control, and/or the like. Still further, the discount management system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code in C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ or ‘at least one of A, B, and C’ are used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

We claim:

1. A method comprising:
associating, by a computer based system for managing a rewards program, a transaction account with the rewards program, wherein the rewards program comprises an offer;
receiving, by the computer based system, transaction information associated with a transaction from a merchant, wherein the transaction information comprises at least one of a transaction value, and a transaction account identifier;
receiving, by the computer based system, a product identifier;
assessing, by the computer based system, the product identifier to determine that the transaction qualifies for a reward based predefined criteria associated with the offer;
determining, by the computer based system, the reward based on the transaction information and the offer; and
providing, by the computer based system, instructions for crediting the reward for the transaction.

2. The method of claim 1, wherein the transaction information further comprises a merchant identifier.

3. The method of claim 2, wherein the determining the reward comprises determining an amount of the reward based on at least one of the transaction account identifier and the merchant identifier, wherein the reward has a monetary value.

4. The method of claim 1, further comprising:
verifying, by the computer based system, completion of the transaction; and
applying, by the computer based system, the reward to the transaction account in response to the completion of the transaction.

5. The method of claim 1, providing, by the computer based system, a record of the reward with the transaction on a statement associated with the transaction account.

6. The method of claim 1, wherein the product identifier is at least one of a SKU code and a UPC code.

7. The method of claim 6, wherein the qualification for the reward is based on at least one of the SKU code and the UPC code.

8. The method of claim 1, wherein a merchant associated with the merchant identifier is not informed of the reward.

9. The method of claim 1, wherein the transaction is initiated by a computing device that comprises a unique computing device indicator, and wherein the unique computing device indicator is associated with the transaction account.

10. The method of claim 9, wherein the product identifier is captured the computing device, prior to initiating the transaction.

11. The method of claim 10, further comprising sending, by the computer based system, a notification of the offer to a user associated with the transaction account to incentivize completion of the transaction.

12. The method of claim 11, wherein the user receives the notification of the offer on the computing device.

13. The method of claim 1, further comprising:
applying, by the computer based system, the reward to the transaction at a point of sale; and
determining, by the computer based system, authorization of the transaction in response to the applying the reward, wherein the reward is a monetary value.

14. The method of claim 1, further comprising:
determining, by the computer based system, authorization of the transaction; and
applying, by the computer based system, the reward to the transaction.

15. The method of claim 1, further comprising:
applying, by the computer based system, the reward to the transaction; and
determining, by the computer based system, authorization of the transaction.

16. The method of claim 1, wherein the transaction is initiated by a computing device, wherein the computing device comprises a unique computing device indicator, and wherein the unique computing device indicator is associated with the transaction account.

17. The method of claim 16, wherein the offer is established by at least one of a transaction account issuer, a loyalty account issuer, a merchant, and a product supplier.

18. The method of claim 16, providing, by the computer based system, the notification of the offer to a user on a computing device.

19. The method of claim 1, Wherein the transaction qualifies for the reward based on at least one of an aggregate transaction history associated with the transaction account, and real time spend data associated with the transaction account.

20. The method of claim 1, wherein the offer contains criteria defining a reward for a class of products, and wherein the product identifier is analyzed to determine that a product associated with the product identifier qualifies for the class of products defined by the criteria.

21. The method of claim 1, wherein the product identifier is received from a computing device.

22. The method of claim 1, crediting, by the computer based system, the reward at a POS.

23. The method of claim 1, wherein the reward is displayed on a statement associated with the transaction account.

24. The method of claim 1, wherein the enrolling is in response to receiving transaction account information associated with the transaction account.

25. A non-transitory, tangible computer-readable storage medium having computer executable instructions stored thereon that, if executed by a computer based system for managing a rewards program, cause the computer based system to perform operations comprising:
associating, by the computer based system, a transaction account with the rewards program, wherein the rewards program comprises an offer;
receiving, by the computer based system, transaction information associated with a transaction from a merchant, wherein the transaction information comprises at least one of a transaction value, and a transaction account identifier;
receiving, by the computer based system, a product identifier;
assessing, by the computer based system, the product identifier to determine that the transaction qualifies for a reward based predefined criteria associated with the offer;
determining, by the computer based system, the reward based on the transaction information and the offer; and
providing, by the computer based system, instructions for crediting the reward for the transaction.

26. A computer based system for managing a product level discount comprising:
a network interface communicating with a memory;
the memory communicating with a processor for managing a rewards program; and
the processor, when executing a computer program, performs operations comprising:
associating, by the processor, a transaction account with the rewards program, wherein the rewards program comprises an offer;
receiving, by the processor, transaction information associated with a transaction from a merchant, wherein the transaction information comprises at least one of a transaction value, and a transaction account identifier;
receiving, by the processor, a product identifier;
assessing, by the processor, the product identifier to determine that the transaction qualifies for a reward based predefined criteria associated with the offer;
determining, by the processor, the reward based on the transaction information and the offer; and
providing, by the processor, instructions for crediting the reward for the transaction.
